(19) United States
(12) Patent Application Publication
(10) Pub. No.: US 2020/0307474 A1
(43) Pub. Date: Oct. 1, 2020

(54) WIRE HARNESS AND SAFETY MANAGEMENT SYSTEM

(71) Applicant: YAZAKI CORPORATION, Tokyo (JP)

(72) Inventor: Hiroyuki Ogura, Makinohara-shi (JP)

(21) Appl. No.: 16/802,558

(22) Filed: Feb. 27, 2020

(30) Foreign Application Priority Data
Mar. 28, 2019 (JP) 2019-062339

(51) Int. Cl. B60R 16/02; B60R 16/023

(52) U.S. Cl. CPC B60R 16/0207; B60R 16/0232

(57) ABSTRACT

A wire harness is routed in a vehicle, is configured to be connected to each of devices having a self-diagnosis function, and has a function of detecting states of the devices separately from the devices. The wire harness includes a harness main body, connection portions provided on end portions of the harness main body respectively and configured to be connected to the devices respectively, a detection unit provided in at least one of the connection portions and configured to detect a state of the device separately from the self-diagnosis function of the each of devices, and a safety management unit configured to capture data of the state of the device.

### CROSS REFERENCE TO RELATED APPLICATIONS

This application is based on Japanese Patent Application (No. 2019-062339) filed on Mar. 28, 2019, the contents of which are incorporated herein by reference.

### BACKGROUND OF THE INVENTION

### 1. Field of the invention

The present invention relates to a wire harness routed in a vehicle and a safety management system including the wire harness.

### 2. Description of the Related Art

In a related art, in an in-vehicle system, an electric and electronic device which is an ECU (an electronics control unit, hereinafter referred to as an “ECU” in the present specification) or the like has its own self-diagnosis function (also referred to as a self-monitoring function), and has performed processing of sharing a state of itself with another device or notifying the state of itself to an occupant which is a driver or the like with an indicator which is a lamp or the like (see, for example, JP-A-2019-1248).

It is predicted that an autonomous vehicle will spread in the future, in this autonomous vehicle, the driver is basically absent. Therefore, fail-operability is required instead of fail-safe so as to ensure functional safety, and a device related to continuity of automatic driving needs to be dealt with duplication of the device or the like.

It is considered that monitoring by a third party is required in addition to a self-diagnosis of the device so as to detect a failure and an abnormality of the device, switch a system based thereon, and the like. However, cost of the system may increase so as to ensure a high degree of the functional safety, so that a solution has been desired.

### SUMMARY OF THE INVENTION

The present invention has been made in view of the above circumstances. An aspect of the present invention provides a wire harness and a safety management system including the wire harness which are capable of duplicating monitoring of a state of a device to ensure functional safety while reducing cost.

There is provided a wire harness which is routed in a vehicle, is configured to be connected to each of devices having a self-diagnosis function, and has a function of detecting states of the devices separately from the self-diagnosis function of the each of devices.

According to the above configuration, the wire harness has the function of detecting the state of the device having the self-diagnosis function separately from the self-diagnosis function of the each of devices. Therefore, there is no need to newly provide a sensor or to newly route a line (a power supply line, a ground. line, a signal line, or the like) to the sensor.

For example, the wire harness includes a harness main body configured to electrically connect the devices, connection portions provided on end portions of the harness main body respectively and configured to be connected to the devices respectively, a detection unit provided in at least one of the connection portions and configured to detect a state of the device separately from the self-diagnosis function of the each of devices, and a safety management unit configured to capture data of the state of the device detected by the detection unit, in which the safety management unit has a function of detecting an abnormal state of the device, storing the abnormal state, and warning an occupant of the vehicle that the device is in the abnormal state.

According to the above configuration, the connection portion provided in each of the terminals of the harness main body includes the detection unit. Therefore, power is supplied to the device and the data of the state of the device that has been detected by the detection unit are collected through the harness main body. Accordingly, the connection portion includes the detection unit, so that there is no need to newly provide a sensor or to newly route a line (a power supply line, a ground line, a signal line, or the like) to the sensor.

Also, the safety management unit is provided. Accordingly, the safety management unit, which has captured the data of the state of the device that has been detected by the detection unit, detects the abnormal state of the device, stores the abnormal state, and warns the occupant of the vehicle that the device is in the abnormal state.

For example, the detection unit is provided so as to be in contact with the device when the connection portion provided with the detection unit is connected to the device.

According to the above configuration, the detection unit is provided to be in contact with the device so as to detect the state of the device. Therefore, the detection can be performed under a condition that the detection unit is in contact with the device to be detected.

For example, the detection unit is configured to detect at least one of a temperature, humidity, a vibration, and power consumption of the device which is to be detected by the detection unit.

According to the above configuration, for example, if an abnormality occurs due to heat in the device to which the connecting portion is connected, a temperature change is observed at a frontage of the device. if a bracket that fixes the device to which the connection portion is connected to a vehicle body is loosened, the state is detected by a vibration.

There is provided a safety management system including the wire harness, and a server located outside a vehicle, in which the safety management unit of the wire harness has a function of transmitting and receiving data to and from the server.

According to the above configuration, the data is transmitted and received between the safety management unit and the server. The data is transmitted and received, so that data of a data analysis and data of an analysis result are stored in the server. The data has been stored in the server is transmitted to the safety management unit.

According to the present invention, it is possible to duplicate the monitoring of a state of a device to secure the functional safety while reducing the cost.

### BRIEF DESCRIPTION OF DRAWINGS

FIG. 1 is a schematic configuration diagram showing a safety management system according to a first embodiment of the present invention.

FIG. 2 is a schematic configuration diagram centering an ECU indicated by an arrow A in FIG. 1.

FIG. 3 is a schematic configuration diagram showing a wire harness according to the present invention.

FIG. 4 is a perspective view of a connection portion connector) of the wire harness and the ECU.

FIG. 5 is a block diagram showing a safety management unit according to the first embodiment.

FIG. 6 is a flowchart showing processing in the safety management unit.

FIG. 7 is a flowchart showing processing in the safety management unit following that in FIG. 6.

FIG. 8 is a schematic configuration diagram showing a safety management system according to a second embodiment of the present invention.

FIG. 9 is a schematic configuration diagram centering an ECU indicated by an arrow B in FIG. 8.

FIG. 10 is a block diagram showing a safety management unit according to the second embodiment.

### DESCRIPTION OF EMBODIMENTS

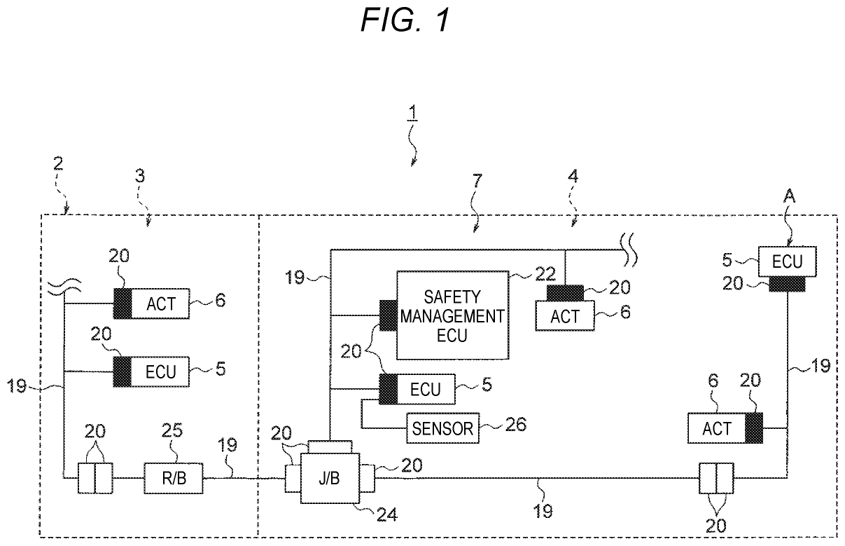

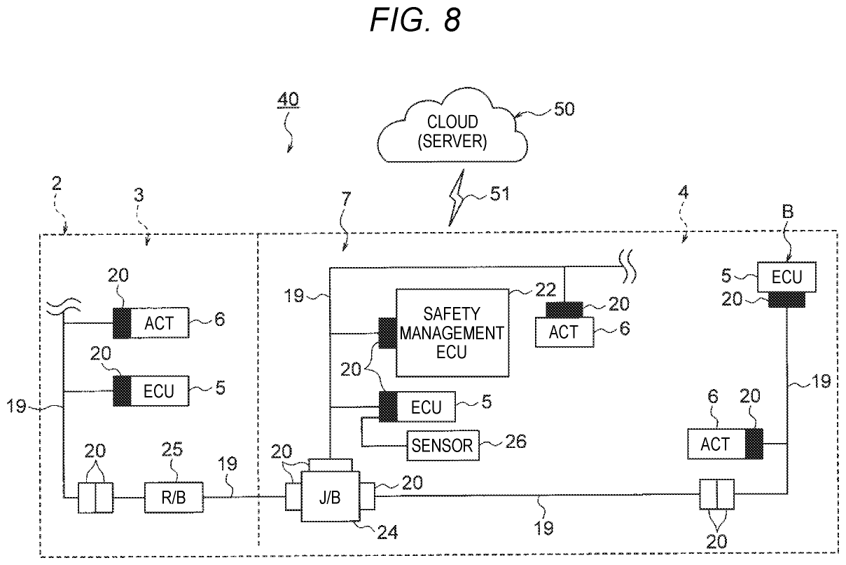

A wire harness according to the present invention and a safety management system including the wire harness according to a first embodiment will be described below with reference to FIGS. 1 to 7. The wire harness according to the present invention and a safety management system according to a second embodiment will be described below with reference to FIGS. 8 to 10.

### First Embodiment

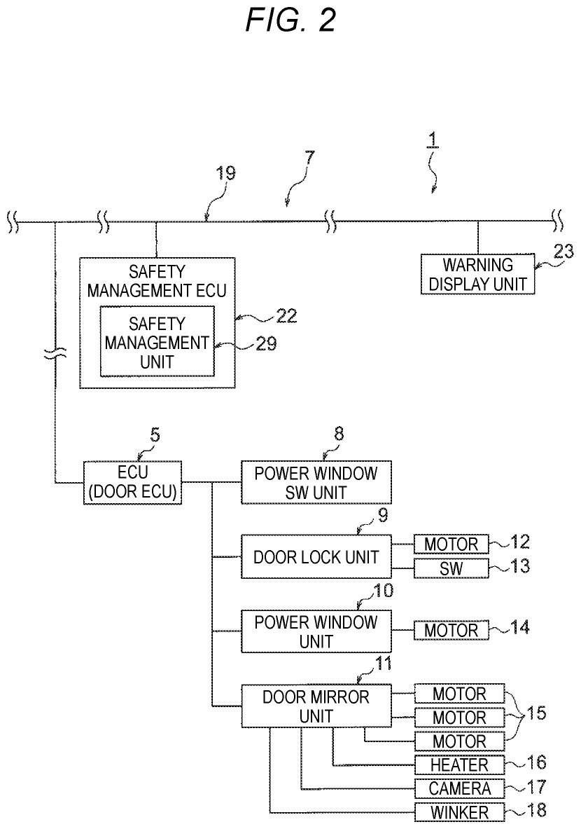

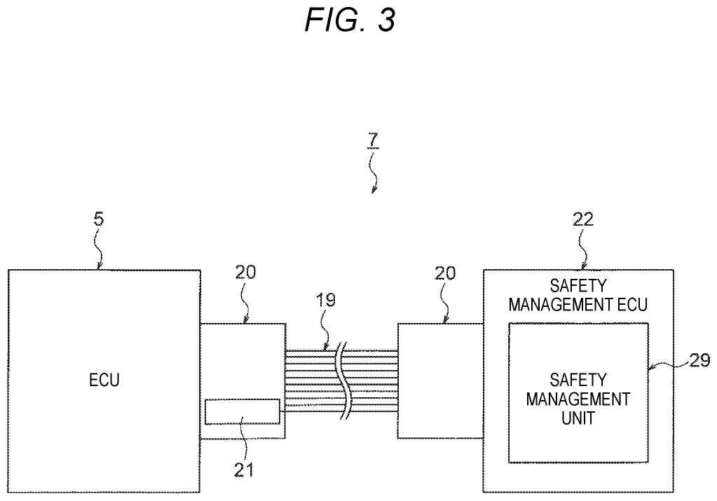

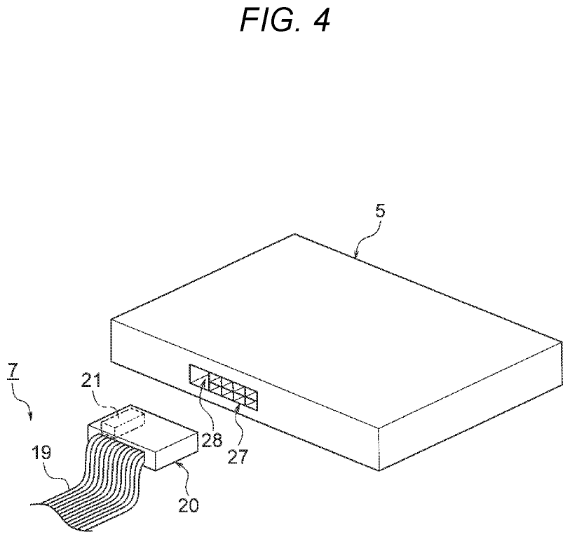

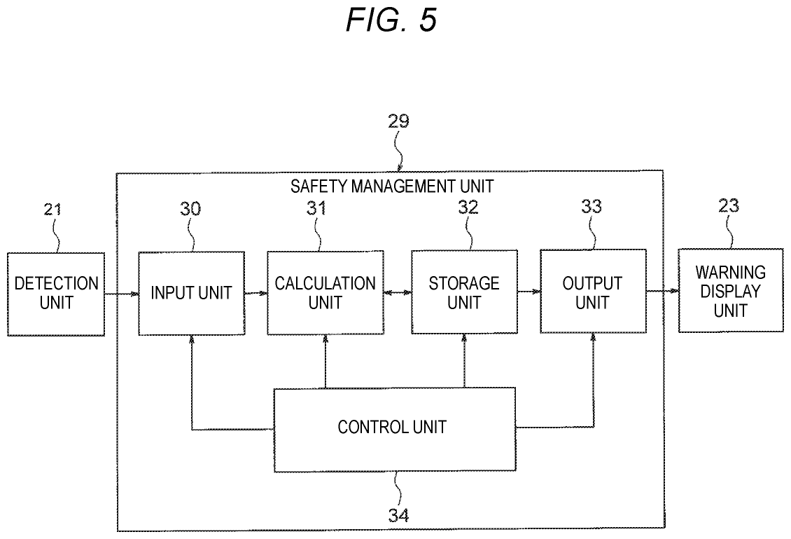

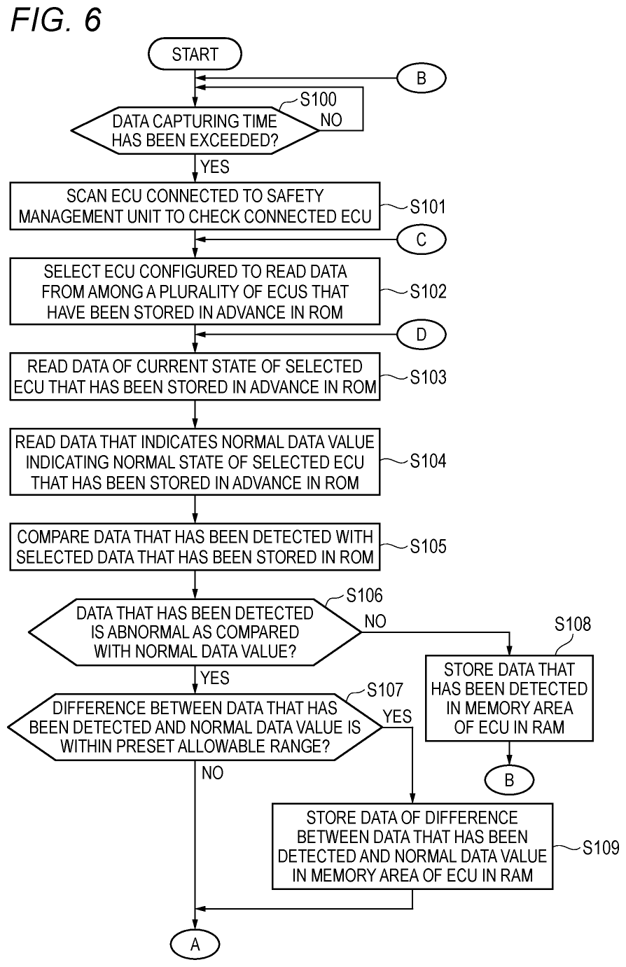

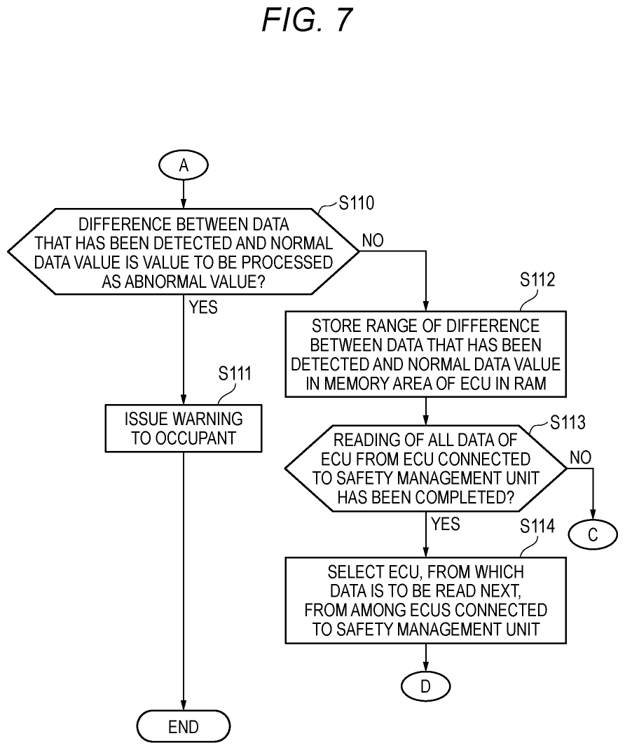

FIG. 1 is a schematic configuration diagram showing the safety management system according to the first embodiment of the present invention. FIG. 2 is a schematic configuration diagram centering an ECU indicated by an arrow A in FIG. 1. FIG. 3 is a schematic configuration diagram showing the wire harness according to the present invention. FIG. 4 is a perspective view of a connection portion (a connector) of the wire harness and the ECU. FIG. 5 is a block diagram showing a safety management unit according to the first embodiment. FIG. 6 is a flowchart showing processing in the safety management unit. FIG. 7 is a flowchart showing processing in the safety management unit following that in FIG. 6.

In FIG. 1, a reference numeral 1 denotes the safety management system according to the present embodiment. The safety management system 1 according to the present embodiment is routed in a vehicle 2 and is configured to display states of an ECU 5 provided in an engine room 3 of the vehicle 2 and an actuator 6 provided in a vehicle interior 4 of the vehicle 2 to an occupant such as a driver (hereinafter referred to as an “occupant” in the present specification). The safety management system 1 according to the present embodiment includes a wire harness 7 according to the present invention. Hereinafter, the ECU 5, the actuator 6, and the wire harness 7 will be described.

First, the ECU 5 and the actuator 6 will be described.

The ECU 5 and the actuator 6 in the present embodiment correspond to the “device having a self-diagnosis function”. The ECU 5 and the actuator 6 have a function of diagnosing the states thereof.

Each of the ECU 5 and the actuator 6 includes a connector receiving portion 27 and a detection unit receiving portion 28 on one side surface thereof (see FIG. 4). The connector receiving portion 27 is formed such that a connector 20 (described below) is electrically connectable thereto. The detection unit receiving portion 28 is formed such that a detection unit 21 (described below) provided in the connector 20 is electrically connectable thereto.

Here, for example, the ECU 5 (here, referred to as a “door ECU 5”) indicated by an arrow A in FIG. I is a control device configured to control various types of operation at a door (not shown) of the vehicle 2, and is an electronic control unit including a computer. The door ECU 5 is configured to control each of a door lock unit 9, a power window unit 10, and a door mirror unit 11 which are shown in FIG. 2 based on, for example, an operation input of the occupant of the vehicle 2 to an operation switch or a command received from another ECU 5. A power window switch unit 8 shown in FIG. 2 is a switch to which an operation input for opening and closing a. power window of the door is performed.

The door lock unit 9 includes a door lock mechanism (not shown) configured to lock and unlock the door. The door lock unit 9 includes a motor 12 and a switch 13, The motor 12 is a drive device configured to drive the door lock mechanism. The switch 13 is configured to switch the door lock mechanism between a locked state and an unlocked state. An operation input for locking and unlocking the door lock mechanism is performed to the switch 13. The door lock unit 9 is configured to lock and unlock the door in response to an operation input to the switch 13.

The power window unit 10 includes a motor 14. The motor 14 is an actuator configured to open and close a window of the door. The power window unit 10 is configured to open and close the window of the door by a force generated by the motor 14 in response to an operation input to the power window switch unit 8.

The door mirror unit 11 includes motors 15, a heater 16, a camera 17, and a winker 18. The motors 15 are actuators configured to open and close a door mirror or adjust a position thereof. The heater 16 is a heating device configured to heat the door mirror. The camera 17 is configured to image a periphery of the vehicle. The winker 18 is a direction indicator provided on the door mirror.

Next, the wire harness 7 according to the present invention will be described.

As illustrated in FIG. 1, the wire harness 7 is routed in the vehicle 2. The wire harness 7 is connected to the ECU 5 and the actuator 6 which have a self-diagnosis function, and has a function of detecting the states of these devices separately from the ECU 5 and the actuator 6.

The wire harness 7 shown in FIGS. 1 and 2 includes a harness main body 19, connectors (connection portions) 20, detection units 21, a safety management ECU 22, and a warning display unit 23. A reference numeral 24 denotes a junction block (an electrical connection box), a reference numeral 25 denotes a relay box, and a reference numeral 26 denotes a sensor. The junction block 24, the relay box 25, and the sensor 26 are each known, so that a detailed description thereof will be omitted. Hereinafter, each configuration of the wire harness 7 will be described.

First, the harness main body 19 will be described.

As shown in FIGS. 1 and 2, the harness main body 19 is configured to electrically connect various devices which are the ECU 5, the actuator 6, the safety management ECU 22, the warning display unit 23, the junction block 24, and the like. The harness main body 19 according to the present embodiment has a function as a power supply line and a function as a communication line (a so-called conductive line for serial communication).

Next, the connector 20 will be described.

The connector 20 shown in FIG. 1 corresponds to a “connection portion”. As shown in FIG. 1, the connector 20 is provided at each end portion of the harness main body 19, and is connected to each of the various devices (the ECU 5, the actuator 6, the safety management ECU 22, and the junction block 24 in FIG. 1). As illustrated in FIG. 4, the connector 20 is formed so as to be connectable to the connector receiving portion 27 provided on the one side surface of the ECU 5.

As will be described below, the detection unit 21 is provided in the connector 20 that is connected to the device having a self-diagnosis function among connectors 20 (see FIGS. 3 and 4).

Next, the detection unit 21 will be described.

The detection unit 21 is a sensor configured to detect the states of the devices (the ECU 5 and the actuator 6 in FIG. 1) having a self-diagnosis function separately from these devices. As shown in FIGS. 3 and 4, the detection unit 1 is provided in the connector 20. The detection unit 21 is not provided in all of the connectors 20, but is provided in the connector 20 (the connector 20 colored in black in FIG. I) that is connected to the device having the self-diagnosis function.

The detection unit 21 is provided so as to be in contact with the device when the connector 20 is connected to the ECU 5 or the actuator 6. More specifically, the detecting unit 21 is formed so as to be connectable to the detection unit receiving portion 28 when the connector 20 is connected to the connector receiving portion 27. According to the detection unit 21, it is possible to detect the state of the device at a frontage of the ECU 5 or the like.

The detection unit 21 is adapted to data to be collected regarding the ECU 5 and the actuator 6 which are to be detected by the detection unit 21. The detection unit 21 is configured to detect at least one of a temperature, humidity, a vibration, and power consumption (current) of the ECU 5 and the actuator 6 which are to be detected by the detection unit 21 (the applications are an example, and a detection unit for other applications may be used).

Next, the safety management ECU 22 will be described.

The safety management ECU 22 is a control device configured to control various types of operation in safety management of the states of the ECU 5 and the actuator 6, and is an electronic control unit including a computer. The safety management ECU 22 includes a safety management unit 29.

The safety management unit 29 is configured to capture the data of the state of the ECU 5 or the actuator 6 that has been detected by the detection unit 21. The safety management unit 29 has a function of detecting an abnormal state of the ECU 5 or the actuator 6, storing the abnormal state, and warning the occupant of the vehicle 2 that the ECU 5 or the actuator 6 is in the abnormal state. As shown in FIG. 5, the safety management unit 29 includes an input unit 30, a calculation unit 31, a storage unit 32, an output unit 33, and a control unit 34.

The input unit 30 is electrically connected to the detection unit 21. The data of the state of the device (the ECU 5 or the like) that has been detected by the detection unit 21 is input to the input unit 30 via the wire harness 7.

The calculation unit 31 is, for example, a central processing unit (CPU), and is configured to perform various calculations. The calculation unit 31 is configured to perform the calculation based on, for example, data output from the input unit 30 and various types of data stored in the storage unit 32. The calculation unit 31 is configured to output a calculation result to the output unit 33.

The storage unit 32 includes, for example, a random access memory (a RAM), a read only memory (a ROM), and the like. The storage unit 32 is connected to the calculation unit 31, and is configured to read and write the various types of data or the like by the calculation unit 31.

The output unit 33 is configured to output the calculation result output from the calculation unit 31 to the warning display unit 23 (described below).

The control unit 34 is an electronic control unit configured to perform operation of each of the input unit 30, the calculation unit 31, the storage unit 32, and the output unit 33. The control unit 34 is configured to store in advance a control program for operating as the input unit 30, the calculation unit 31, the storage unit 32, and the output unit 33. In the control unit 34, the input unit 30, the calculation unit 31, the storage unit 32, and the output unit 33 may be separate control circuits or a common control circuit.

Next, the warning display unit 23 will be described.

The warning display unit 23 is a transmission unit configured to transmit a message (a warning) to the occupant in the vehicle 2. The warning display unit 23 is provided, for example, in a meter in front of a driver seat. The warning display unit 23 according to the present embodiment is configured to transmit the message to the occupant by visual information which is, for example, a character or a symbol.

The warning display unit 23 is not limited to the above-described aspect, and may use other aspects. For example, the warning display unit 23 may transmit the message to the occupant by auditory information which is audio or the like instead of or in addition to the visual information. The warning display unit 23 may transmit the message to the occupant by a vibration or the like.

Next, operation of the safety management system 1 according to the present embodiment will be described with reference to FIGS. 6 and 7. The flowcharts shown in FIGS. 6 and 7 are repeatedly executed by the safety management system 1. In the flowcharts shown in FIGS. 6 and 7, the device whose state is to be detected is, for example, the ECU 5 indicated by the arrow A in FIG. 1.

First, in step S100 shown in FIG. 6, the calculation unit 31 determines whether a time (hereinafter, referred to as a “data capturing time”), which is a timing for capturing the data of the state of the ECU 5 that has been detected by the detection unit 21, has been exceeded. Specifically, the calculation unit 31 sets the data capturing time in advance. If the calculation unit 31 determines that the set data capturing time has been exceeded (Yes determination), the process proceeds to step S101. If the calculation unit 31 determines that the set data capturing time has not been exceeded (No determination), step S100 is repeated.

In step S101, the calculation unit 31 scans the ECU 5 connected to the safety management unit 29 to check the connected ECU 5. Specifically, the calculation unit 31 checks the ECU 5 to which the connector 20 including the detection unit 21 is connected among ECUs 5. Thereafter, the process proceeds to step S102.

In step S102, the calculation unit 31 selects the ECU 5 to read data thereof from among a plurality of the ECUs 5 that have been stored in advance in the ROM of the storage unit 32. Here, the ECU 5 indicated by the arrow A in FIG. 1 is selected as the ECU 5 to read data thereof. Thereafter, the process proceeds to step S103.

In step S103, the calculation unit 31 reads data (data of the current state of the ECU 5 that has been detected by the detection unit 21) of a current state of the selected ECU 5 that has been stored in advance in the ROM of the storage unit 32. Thereafter, the process proceeds to step S104.

In step S104, the calculation unit 31 reads data that indicates a normal data value indicating a normal state of the selected ECU 5 that has been stored in advance in the ROM of the storage unit 32. Thereafter, the process proceeds to step S105.

In step S105, the calculation unit 31 compares the data that has been detected by the detection unit 21 with the selected data that has been stored in the ROM of the storage unit 32. Thereafter, the process proceeds to step S106.

In step S106, the calculation unit 31 determines whether the data that has been detected by the detection unit 21 is abnormal as compared with the normal data value. If the calculation unit 31 determines that the data detected by the detection unit 21 is abnormal (Yes determination), the process proceeds to step S107. If the calculation unit 31 determines that the data detected by the detection unit 21 is not abnormal (No determination), the process proceeds to step S108.

In step S107, the calculation unit 31 determines whether a difference between the data that has been detected by the detection unit 21 and the normal data value is within a preset allowable range. If the calculation unit 31 determines that the difference is within the allowable range (Yes determination), the process proceeds to step S109. If the calculation unit 31 determines that the difference is not within the allowable range (No determination), the process proceeds to step S110 (see a symbol A shown in FIGS. 6 and 7).

In step S108, the storage unit 32 stores the data that has been detected by the detection unit 21 in a memory area of the ECU 5 in the RAM. Thereafter, the process returns to step S100, and the operation flow is repeated (see a symbol B shown in FIG. 6).

In step S109, the storage unit 32 stores the data of the difference between the data that has been detected by the detection unit 21 and the normal data value in the memory area of the ECU 5 in the RAM. Thereafter, the process proceeds to step SII0 (see the symbol A shown in FIGS. 6 and 7).

In step S110 shown in FIG. 7, the calculation unit 31 determines whether the difference between the data that has been detected by the detection unit 21 and the normal data value is a value to be processed as an abnormal value. If the calculation unit 31 determines that the difference is the value to be processed as an abnormal value (Yes determination), the process proceeds to step S111. If the calculation unit 31 determines that the difference is not the value to be processed as an abnormal value (No determination), the process proceeds to step S112.

In step S111, the output unit 33 outputs the calculation result (the determination that the difference is the value to be processed as an abnormal value) in step S110 to the warning display unit 23. Thereafter, the warning display unit 23 issues the message (the warning) to the occupant by the visual information which is, for example, a character or a symbol, and the operation flow ends.

In step S112, the storage unit 32 stores a range of the difference between the data that has been detected by the detection unit 21 and the normal data value in the memory area of the ECU 5 in the RAM. Thereafter, the process proceeds to step S113.

In step S113, the calculation unit 31 determines whether reading of all the data of the ECU 5 from the ECU 5 connected to the safety management unit 29 has been completed. If the calculation unit 31 determines that the reading has been completed (Yes determination), the process proceeds to step S114. If the calculation unit 31 determines that the reading has not been completed (No determination), the process returns to step S102, and the operation flow is repeated (see a symbol C shown in FIGS, 6 and 7).

In step S114, the calculation unit 31 selects an ECU, from which data is to be read next, from among the ECUs connected to the safety management unit 29. Thereafter, the process returns to step S103, and the operation flow is repeated (see a symbol D shown in FIGS. 6 and 7).

According to the present embodiment as described above, the data that has been detected by the detection unit 21 is transmitted as an analog signal or a digital signal via the wire harness 7, and can be utilized by being managed and analyzed by the safety management unit 29, being shared among the devices such as the ECU 5, and the like.

The present embodiment is also effective for the following problems.

That is, in the related art, a failure analysis by self-diagnosis is difficult for an electric and electronic device which is an ECU or the like in which a failure has occurred, and log data has been required to be available in a certain degree for usage environment thereof. As long as the data is present, a further advanced application may be performed, but there is no such mechanism at present.

According to the present embodiment, it is possible to find what kind of environmental change has occurred before and after occurrence of a failure or an abnormality in accordance with self-diagnosis and status information of a device which is the ECU 5 or the like in which the failure or the abnormality has occurred, Which can used to analyze a cause of the failure or the abnormality. It is possible not only to improve design that causes the failure or the abnormality, but also to provide a reference to develop new power supply control logic of warning for a situation or a condition under which the failure or the abnormality may occur again during use of the device, reducing a current value before the device falls into the above-described situation, or the like.

As a mechanism according to the present embodiment becomes widespread, it is possible to reduce the occurrence of a failure or an abnormality of the device which is the ECU 5 or the like, and to satisfy a need for an in-vehicle electric and electronic device which is required to be highly reliable for an autonomous vehicle or the like.

Next, effects of the present embodiment will be described.

As described above with reference to FIGS. 1 to 7, according to the present embodiment, a state of a device which is the ECU 5 or the like can be monitored by a third party via the wire harness 7, and reliability of grasping a system state can be improved. Therefore, it is possible to duplicate the monitoring of the state of the device to secure functional safety while reducing cost.

In addition, the present embodiment can support an analysis of a cause of a deterioration, a failure, or the like which is difficult only by a self-diagnosis by the device which is the ECU 5 or the like, and can be expected to be effective for a design improvement, a failure prediction, generation of the power supply control logic, and the like.

### Second Embodiment

The wire harness and the safety management system according to the present invention may use the following second embodiment in addition to the first embodiment. Hereinafter, the second embodiment will be described with reference to FIGS. 8 to 10.

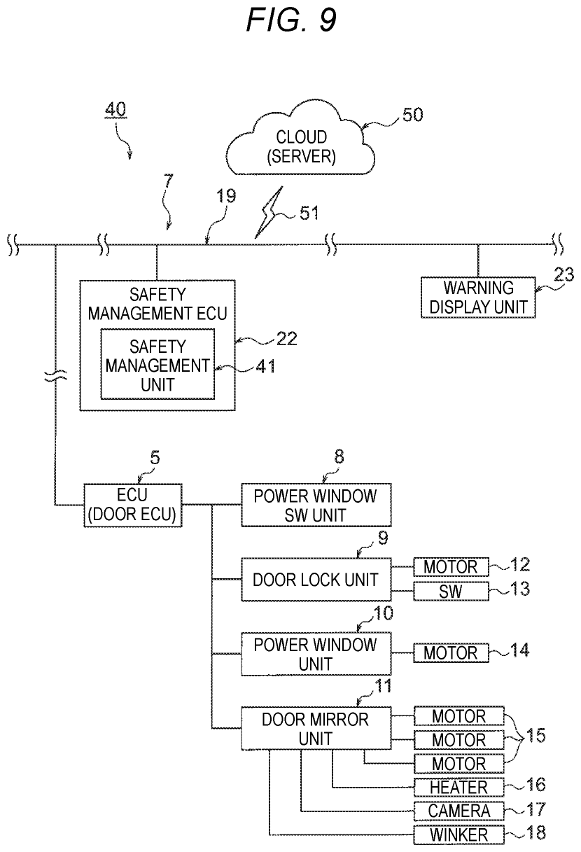

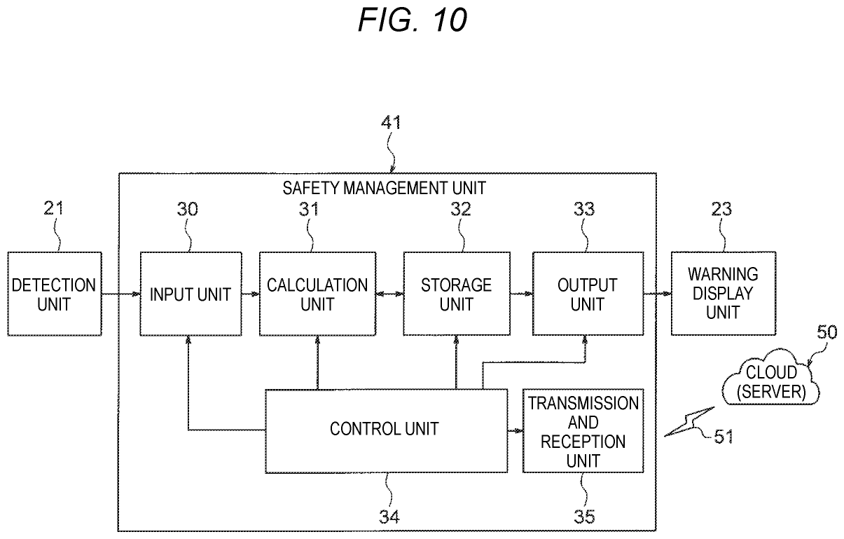

FIG. 8 is a schematic configuration diagram showing the safety management system according to the second embodiment of the present invention. FIG. 9 is a schematic configuration diagram centering an ECU indicated by an arrow B in FIG. 8. FIG. 10 is a block diagram showing a safety management unit according to the second embodiment.

The same components as those in the above-described first embodiment are denoted by the same reference numerals, and a detailed description thereof is omitted.

In FIG. 8, a reference numeral 40 denotes the safety management system according to the present embodiment. The safety management system 40 shown in FIG. 8 is different from the first embodiment in that the safety management system 40 includes a cloud (a server) 50 provided outside the vehicle 2 and a transmission and reception unit 35 in a safety management unit 41.

The cloud 50 shown in FIGS. 8 to 10 corresponds to a “server”. The cloud 50 is capable of transmitting and receiving data to and from the transmission and reception unit 35 (described below) of the safety management unit 41 by a wireless unit 51. The cloud 50 is configured to store data from the safety management unit 41, but is not limited thereto and may have a function of analyzing the data from the safety management unit 41.

As shown in FIG. 10, the safety management unit 41 has basically the same configuration as the safety management unit 29 (see FIG. 5) according to the first embodiment except that the safety management unit 41 includes the transmission and reception unit 35. Therefore, a detailed description of a configuration of the safety management unit 41 other than that of the transmission and reception unit 35 is omitted.

The transmission and reception unit 35 shown in FIG. 10 has a function of transmitting and receiving the data to and from the cloud 50. The transmission and reception unit 35 is capable of transmitting and receiving the data to and from the cloud 50 by the wireless unit 51.

Operation of the safety management system 40 according to the present embodiment is basically the same as the operation of the safety management system 1 according to the first embodiment (see FIGS. 6 and 7).

Next, effects of the present embodiment will be described.

As described above with reference to FIGS. 8 to 10, according to the present embodiment, the same effect as that of the first embodiment can be attained.

In addition, it goes without saying that the present invention can be variously modified without departing from the gist of the present invention.

What is claimed is:

1. A wire harness,
wherein the wire harness is routed in a vehicle, is configured to be connected to each of devices having a self-diagnosis function, and has a function of detecting states of the devices separately from the self-diagnosis function of the each of devices.

2. The wire harness according to claim 1, comprising:
a harness main body configured to electrically connect the devices;
connection portions provided on end portions of the harness main body respectively and configured to be connected to the devices respectively;
a detection unit provided in at least one of the connection portions and configured to detect a state of the device separately from the self-diagnosis function of the each of devices; and
a safety management unit configured to capture data of the state of the device detected by the detection unit,
wherein the safety management unit has a function of detecting an abnormal state of the device, storing the abnormal state, and warning an occupant of the vehicle that the device is in the abnormal state.

3. The wire harness according to claim 2,
wherein the detection unit is provided so as to be in contact with the device when the connection portion provided with the detection unit is connected to the device.

4. The wire harness according to claim 2,
wherein the detection unit is configured to detect at least one of a temperature, humidity, a vibration, and power consumption of the device which is to be detected by the detection unit.

5. A safety management system comprising:
the wire harness according to claim 2; and
a server located outside a vehicle,
wherein the safety management unit of the wire harness has a function of transmitting and receiving data to and from the server.
